(19) United States
(12) Patent Application Publication
(10) Pub. No.: US 2024/0120787 A1
(43) Pub. Date: Apr. 11, 2024

(54) MOTOR, COMPRESSOR, AND REFRIGERATION CYCLE APPARATUS

(71) Applicant: Mitsubishi Electric Corporation, Tokyo (JP)

(72) Inventor: Masahiro NIGO, Tokyo (JP)

(21) Appl. No.: 18/546,110

(22) PCT Filed: Mar. 31, 2021
(86) PCT No.: PCT/JP2021/013870

§ 371 Date: Aug. 11, 2023

(51) Int. Cl. H02K 1/276; F25B 13/00; F25B 31/02; H02K 21/16

(52) U.S. Cl. CPC H02K 1/276; F25B 13/00; F25B 31/026; H02K 21/16

(57) ABSTRACT

A rotor has a rotor core having a magnet insertion hole and a permanent magnet inserted therein. The rotor core has a flux barrier. When a straight line in the radial direction passing through a center of the magnet insertion hole in the circumferential direction is defined as a pole center line, a distance W from the pole center line to the flux barrier is shorter than a distance M from the pole center line to an end of the permanent magnet in the circumferential direction. A width A in the radial direction of a bridge formed between the flux barrier and an outer circumference of the rotor core, a width B of the flux barrier in the radial direction, a width C of the magnet insertion hole in a thickness direction of the permanent magnet, and a gap G between the rotor and a stator satisfy A<G<B<C.

### CROSS REFERENCE TO RELATED APPLICATION

This application is a U.S. national stage application of International Patent Application No. PCT/JP2021/013870 filed on Mar. 31, 2021, the disclosure of which is incorporated herein by reference.

### TECHNICAL FIELD

The present invention relates to a motor, a compressor, and a refrigeration cycle apparatus.

### BACKGROUND

A permanent magnet embedded motor has a rotor and a stator surrounding the rotor. The rotor has a plurality of magnet insertion holes in the circumferential direction, and a permanent magnet is disposed in each magnet insertion hole. Each magnet insertion hole corresponds to one magnetic pole. The stator has a plurality of teeth protruding toward the rotor.

In a state where the center of the permanent magnet in the width direction faces one tooth, an end of the permanent magnet in the width direction may face another tooth. In this case, magnetic flux of the permanent magnet may flow into its adjacent permanent magnet through a tooth tip of the another tooth. Such a phenomenon is referred to as a short circuit of magnetic flux. To reduce the short circuit of the magnetic flux, it has been proposed to form an opening elongated in the circumferential direction, at an outer circumferential region of a rotor core (see, for example, Patent Reference 1).

### PATENT REFERENCE

Patent Reference 1: Japanese Patent Application Publication No. 2012-254019 (see FIGS. 4 and 7)

In recent years, there has been a demand to effectively suppress the short circuit of the magnetic flux between magnetic poles in order to further improve motor efficiency.

### SUMMARY

The present disclosure is made to solve the above problem, and an object of the present disclosure is to effectively suppress the short circuit of the magnetic flux between magnetic poles.

A motor of the present disclosure includes a stator in an annular shape extending in a circumferential direction about an axis, and a rotor provided on an inner side of the stator in a radial direction about the axis. The rotor has a rotor core having a magnet insertion hole and a permanent magnet inserted in the magnet insertion hole, the permanent magnet being in the form of a flat plate. The rotor core further has a flux barrier formed on an outer side of the magnet insertion hole in the radial direction so as to be continuous to an end of the magnet insertion hole in the circumferential direction. When a straight line in the radial direction passing through a center of the magnet insertion hole in the circumferential direction is defined as a pole center line, a distance W from the pole center line to the flux barrier is shorter than a distance M from the pole center line to an end of the permanent magnet in the circumferential direction. A width A in the radial direction of a bridge formed between the flux barrier and an outer circumference of the rotor core, a width B of the flux barrier in the radial direction, a width C of the magnet insertion hole in a thickness direction of the permanent magnet, and a gap G between the rotor and the stator satisfy A<G<B<C.

According to the present disclosure, the magnetic flux of the permanent magnet is restrained from flowing into its adjacent permanent magnet via the tooth, and thus it is possible to effectively suppress the short circuit of the magnetic flux between magnetic poles.

### BRIEF DESCRIPTION OF THE DRAWINGS

FIG. 1 is a sectional view illustrating a motor of a first embodiment.

FIG. 2 is a sectional view illustrating the motor of the first embodiment in such a manner that insulating portions and coils are omitted.

FIGS. 3(A) and 3(B) are respectively a sectional view and a perspective view illustrating a split core and the insulating portion of the first embodiment.

FIG. 4 is a sectional view illustrating a rotor of the first embodiment.

FIG. 5 is a diagram illustrating a portion in which the rotor and a stator of the first embodiment face each other.

FIG. 6 is an enlarged diagram illustrating a flux barrier and its surroundings in the first embodiment.

FIG. 7 is a diagram illustrating a portion in which the rotor and the stator of the first embodiment face each other.

FIG. 8 is an enlarged diagram illustrating the flux barrier and its surroundings in the first embodiment.

FIG. 9 is a diagram illustrating a portion in which the rotor and the stator of the first embodiment face each other.

FIG. 10 is a sectional view illustrating a motor of Comparative Example.

FIG. 11 is a diagram illustrating a portion in which a rotor and a stator of the Comparative Example face each other.

FIG. 12 is a schematic diagram for explaining the action of suppressing a short circuit of the magnetic flux in the first embodiment.

FIG. 13 is a diagram illustrating a portion in which a rotor and a stator of a second embodiment face each other.

FIG. 14 is an enlarged diagram illustrating a flux barrier and its surroundings in the second embodiment.

FIG. 15 is a sectional view illustrating a compressor to which the motor of each embodiment is applicable.

FIG. 16 is a diagram illustrating a refrigeration cycle apparatus including the compressor illustrated in FIG. 15.

### DETAILED DESCRIPTION

### First Embodiment

### (Configuration of Motor)

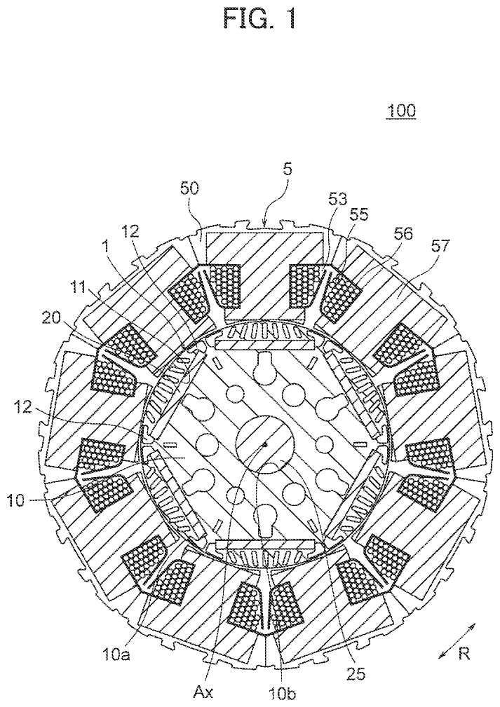

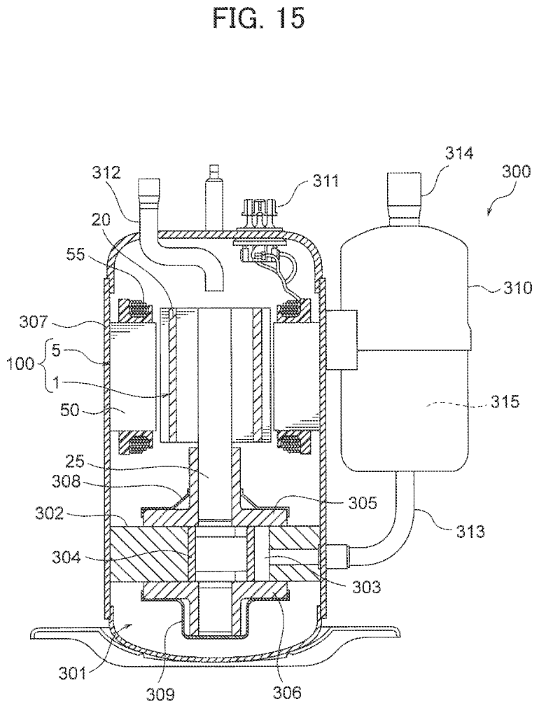

First, a motor 100 of a first embodiment will be described. FIG. 1 is a cross-sectional view illustrating the motor 100 of the first embodiment. The motor 100 is a permanent magnet embedded motor that has permanent magnets 20 embedded in a rotor 1. The motor 100 is used in, for example, a compressor 300 (FIG. 15) and driven by an inverter.

The motor 100 has the rotor 1 that is rotatable and a stator 5 provided to surround the rotor 1. An air gap is formed between the stator 5 and the rotor 1. A gap G between the stator 5 and the rotor 1 is, for example, 0.3 to 1.0 mm, and is 0.75 mm in this example.

Hereinafter, the direction of an axis Ax, which is a rotation axis of the rotor 1, is referred to as an “axial direction”. The circumferential direction about the axis Ax (indicated by the arrow R in FIG. 1 and other figures) is referred to as a “circumferential direction”. The radial direction about the axis Ax is referred to as a “radial direction”.

### (Configuration of Stator)

The stator 5 has a stator core 50, insulating films 56 and insulators 57 that are attached to the stator core 50, and coils 55 wound on the stator core 50.

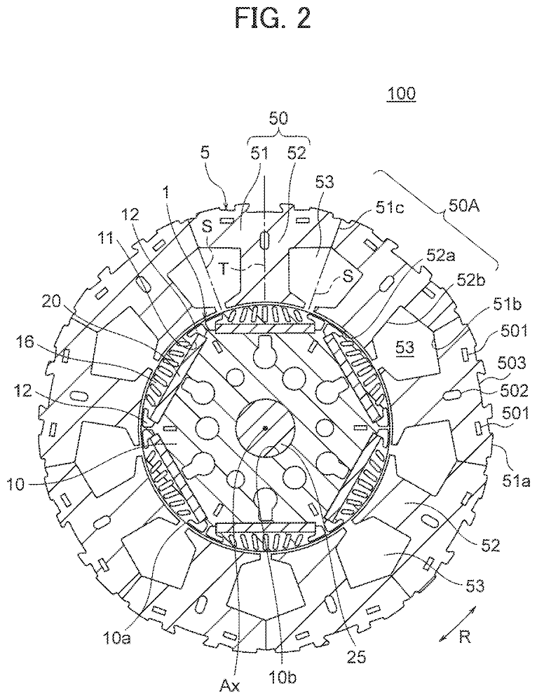

FIG. 2 is a sectional view illustrating the motor 100 in such a manner that the insulating films 56, the insulators 57, and the coils 55 are omitted. The stator core 50 of the stator 5 is composed of electromagnetic steel sheets, which are stacked in the axial direction and fixed together by crimping or the like. The electromagnetic steel sheet has a sheet thickness of, for example, 0.1 to 0.7 mm, and is 0.35 mm in this example.

The stator core 50 has a yoke 51 having an annular shape about the axis Ax, and a plurality of teeth 52 extending inward in the radial direction from the yoke 51. The yoke 51 has an outer circumference 51a and an inner circumference 51b.

The teeth 52 are formed at constant intervals in the circumferential direction. The number of teeth 52 is nine in this example, but only needs to be two or more. A slot 53, in which the coil 55 is housed, is formed between teeth 52 adjacent to each other in the circumferential direction. The number of slots 53 is the same as the number of teeth 52 and is nine in this example.

The tooth 52 has a tooth tip 52a facing the rotor 1. The tooth tip 52a has a rotor facing surface, which is a curved surface along the outer circumference of the rotor core 10. The tooth tip 52a is wider in the circumferential direction than any other portion of the tooth 52. The tooth 52 has side surfaces 52b facing the slots 53.

A straight line in the radial direction that passes through the center of the tooth 52 in the circumferential direction is referred to as a tooth center line T. The side surface 52b of the tooth 52 is parallel to the tooth center line T. The inner circumference 51b of the yoke 51 extends from the base of the tooth 52 in a direction perpendicular to the tooth center line T.

A straight line in the radial direction that passes through the center of the slot 53 in the circumferential direction is defined as a slot center line S. An angle formed between the slot center lines S of two adjacent slots 53 is 40 degrees in mechanical angle and 120 degrees in electrical angle. This angle is also referred to as a winding pitch.

The stator core 50 has a plurality of split cores 50A divided so that each split core 50A includes one tooth 52. The number of split cores 50A is, for example, nine. The split cores 50A are divided at split surfaces 51c formed in the yoke 51. The split cores 50A are connected to each other by, for example, a thin-walled portion formed on the outer circumferential side of the split surface 51c.

The insulating films 56 and the insulators 57 (FIG. 1) are attached to the split cores 50A in a state where the stator core 50 is expanded in a strip shape, and the coils 55 are wound on the stator core 50. Then, the stator core 50 is bent in an annular shape, and both ends of the stator core 50 are welded, so that the annular stator core 50 shown in FIG. 2 is obtained. The stator core 50 is not limited to a configuration in which the plurality of split cores 50A are connected together, but may be formed of a stack of annular electromagnetic steel sheets.

The yoke 51 is provided with crimping portions 501. The crimping portions 501 serve to fix the plurality of electromagnetic steel sheets, which constitute the stator core 50, in the axial direction. The crimping portions 501 are provided at two symmetrical locations with respect to each tooth center line T. The number and arrangement of crimping portions 501 can be changed as appropriate.

The yoke 51 is provided with fitting holes 502. The fitting hole 502 is formed at one location on each tooth center line T. The fitting holes 502 are holes for fixing the insulators 57 (FIG. 1). Recesses 503 are formed on the outer circumference 51a of the yoke 51. Each recess 503 is a portion that forms a refrigerant passage between the recess 503 and a sealed container 307 of the compressor 300 (FIG. 15).

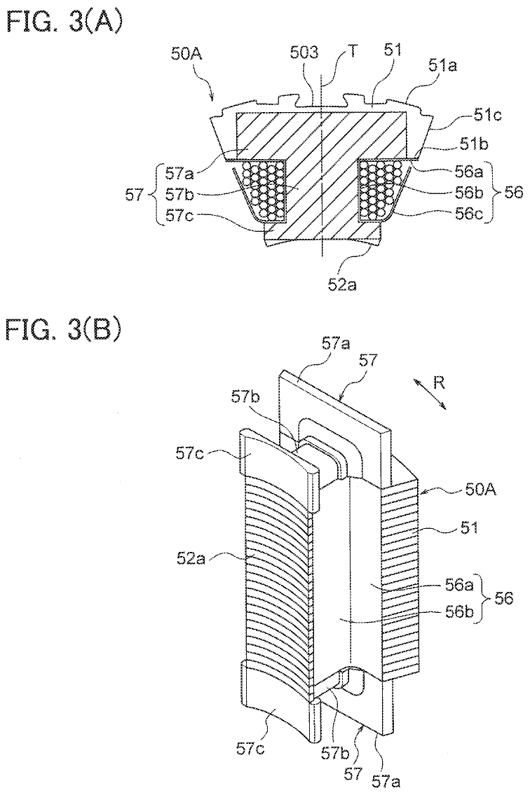

FIG. 3(A) is a sectional view illustrating the split core 50A, the insulating films 56, and the insulator 57 together with the coil 55. FIG. 3(B) is a perspective view illustrating the split core 50A, the insulating film 56, and the insulators 57.

As shown in FIG. 3(A), the insulating film 56 is disposed to cover the inner surface of the slot 53. The insulating film 56 is made of a resin, such as polyethylene terephthalate (PET), and has a thickness of 0.1 to 0.2 nm.

The insulating film 56 has a yoke insulating portion 56a covering the inner circumference 51b of the yoke 51, a tooth insulating portion 56b covering the side surface 52b of the tooth 52, and a folded portion 56c extending from the end of the tooth insulating portion 56b into inside the slot 53.

The insulators 57 are provided at both ends of the stator core 50 in the axial direction as illustrated in FIG. 3(B). Each insulator 57 is a resin molded body made of polybutylene terephthalate (PBT) or the like. The insulator 57 has a not-shown convex portion that fits into the fitting hole 502 (FIG. 2) of the split core 50A and is fixed to the split core 50A by fitting the convex portion into the fitting hole 502.

The insulator 57 has an outer wall portion 57a, a body portion 57b, and an inner wall portion 57c. The outer wall portion 57a, the body portion 57b, and the inner wall portion 57c are disposed at the ends in the axial direction of the yoke 51, tooth 52, and tooth tip 52a, respectively. The coil 55 is wound on the body portion 57b, and the outer wall portion 57a and the inner wall portion 57c guide the coil 55 from both sides in the radial direction.

The insulating film 56 and the insulator 57 constitute an insulating portion that insulates the coil 55 from the stator core 50. However, the insulating portion is not limited to this configuration, but only needs to be configured to insulate the coil 55 from the stator core 50.

The coil 55 is composed of, for example, a magnet wire, and wound around the tooth 52 via the insulating film 56 and the insulator 57. The coil 55 has a wire diameter of, for example, 0.8 mm. The coil 55 is wound, for example, 70 turns around each tooth 52 in concentrated winding. The wire diameter and number of turns of coil 55 are determined in accordance with the required rotation speed, torque, applied voltage, or cross-sectional area of the slot 53.

### (Configuration of Rotor)

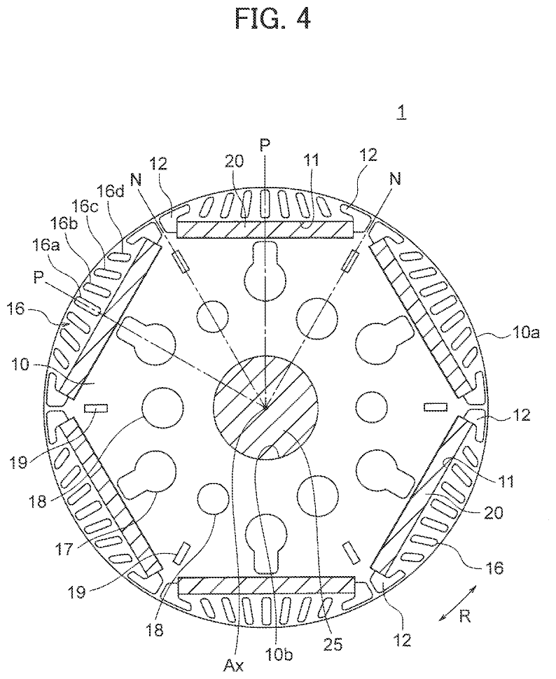

FIG. 4 is a sectional view illustrating the rotor 1. As illustrated in FIG. 4, the rotor 1 has a rotor core 10 of a cylindrical shape, the permanent magnets 20 attached to the rotor core 10, and a shaft 25 fixed at the center of the rotor core 10. A balance weight may be attached to the end of the rotor core 10 in the axial direction so as to increase inertia.

The rotor core 10 is formed of electromagnetic steel sheets, which are stacked in the axial direction and fixed together by crimping or the like. The electromagnetic steel sheet has a sheet thickness of, for example, 0.1 to 0.7 mm, and is 0.35 mm in this example. The rotor core 10 has an outer circumference 10a and an inner circumference 10b. Each of the outer and inner circumferences 10a and 10b is circular about the axis Ax.

The shaft 25, which is the rotation shaft, is fixed to the inner circumference 10b of the rotor core 10 by shrink-fitting or press-fitting. The center axis of the shaft 25 coincides with the axis Ax described above.

A plurality of magnet insertion holes 11 are formed along the outer circumference 10a of the rotor core 10. The magnet insertion holes 11 are formed at equal intervals in the circumferential direction. Each magnet insertion hole 11 extends from one end to the other end of the rotor core 10 in the axial direction.

One permanent magnet 20 is disposed in each magnet insertion hole 11. Each magnet insertion hole 11 corresponds to one magnetic pole. The number of magnet insertion holes 11 is six in this example, and therefore the number of magnetic poles is six. However, the number of magnetic poles is not limited to six, but only needs to be two or more.

The center of the magnet insertion hole 11 in the circumferential direction is the pole center. A straight line in the radial direction that passes through the pole center is referred to as a pole center line P. The magnet insertion hole 11 extends linearly in a direction perpendicular to the pole center line P. An angle formed between pole center lines P of two adjacent magnetic poles is 60 degrees in mechanical angle and 180 degrees in electrical angle. This angle is also referred to as a magnetic pole pitch.

An inter-pole portion is formed between adjacent magnet insertion holes 11, i.e., between adjacent magnetic poles. A straight line in the radial direction that passes through the middle position between adjacent magnet insertion holes 11 is referred to as an inter-pole center line N.

The permanent magnet 20 is formed of, for example, a neodymium rare earth magnet containing neodymium (Nd), iron (Fe) and boron (B).

The permanent magnet 20 is in the form of a flat plate and has a width in the circumferential direction of the rotor core 10 and a thickness in the radial direction of the rotor core 10. The permanent magnet 20 is magnetized in a direction orthogonal to its wider surface, i.e., in the thickness direction. In other words, the permanent magnet 20 has a thickness in the magnetizing direction. The permanent magnet 20 has a thickness of, for example, 2 mm.

Holes 17 and 18, which serve as passages for the refrigerant, are formed on the inner side of the magnet insertion holes 11 in the radial direction. The hole 17 is formed on the pole center line P, while the hole 18 is formed on the inter-pole center line N. Crimping portions 19 for fixing the electromagnetic steel sheets of the rotor core 10 are formed on the outer side of the holes 18 in the radial direction on the inter-pole center line N. The arrangement of the holes 17 and 18 and the crimping portions 19 can be changed as appropriate.

### (Configuration to Suppress Short Circuit of Magnetic Flux)

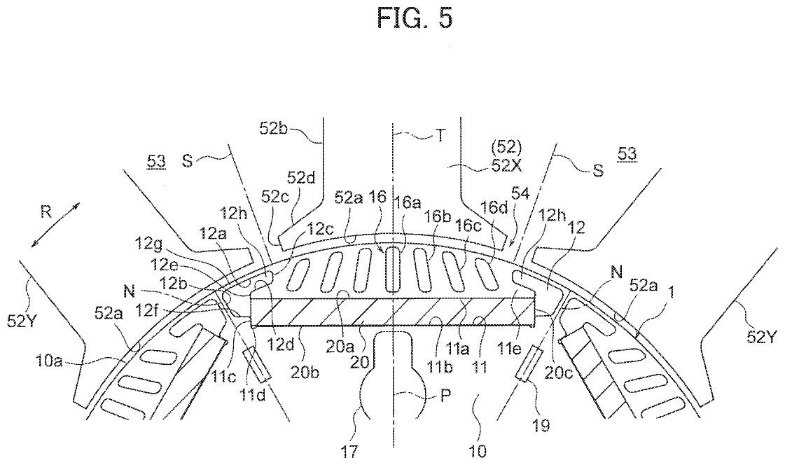

Next, a description will be given on a configuration to suppress the short circuit of the magnetic flux in the first embodiment. FIG. 5 is a diagram illustrating a portion in which the rotor 1 and the stator 5 of the first embodiment face each other. The permanent magnet 20 inserted in the magnet insertion hole 11 has a magnetic pole surface 20a located on the outer side in the radial direction, a back surface 20b located on the inner side in the radial direction, and side end surfaces 20c located on both sides in the circumferential direction. Both the magnetic pole surface 20a and the back surface 20b are surfaces perpendicular to the pole center line P.

The thickness of the permanent magnet 20 is an interval between the magnetic pole surface 20a and the back surface 20b, and is, for example, 2.0 mm. The width of the permanent magnets 20 is an interval between the two side end surfaces 20c. In the first embodiment, the thickness direction of the permanent magnet 20 is parallel to the pole center line P, and the width direction of the permanent magnet 20 is perpendicular to the pole center line P.

The magnet insertion hole 11 has an outer edge 11a located on the outer side in the radial direction and an inner edge lib located on the inner side in the radial direction. The outer edge 11a of the magnet insertion hole 11 faces the magnetic pole surface 20a of the permanent magnet 20, while the inner edge lib of the magnet insertion hole 11 faces the back surface 20b of the permanent magnet 20.

Stepped portions 11c that contact the side end surfaces 20c of the permanent magnet 20 are formed on both sides in the circumferential direction of the inner edge 11b of the magnet insertion hole 11. Each stepped portion 11c protrudes from the inner edge 11b into inside the magnet insertion hole 11, and its protruding amount is, for example, 0.5 mm. The stepped portions 11c of the magnet insertion hole 11 restrict the position of the permanent magnet 20 in the magnet insertion hole 11.

A semicircular groove 11d is formed between the inner edge lib and the stepped portion 11c of the magnet insertion hole 11. The groove lid serves to prevent rounding of the corner between the inner edge 11b and the stepped portion 11c during a punching process of the electromagnetic steel sheet.

Flux barriers 12, which are openings, are formed on both sides of the magnet insertion hole 11 in the circumferential direction. Each flux barrier 12 extends from the end of the magnet insertion hole 11 in the circumferential direction toward the outer circumference 10a of the rotor core 10. The flux barrier 12 is provided to suppress the short circuit of the magnetic flux between the adjacent magnetic poles.

A group of slits 16 is formed between the outer circumference 10a of the rotor core 10 and the magnet insertion hole 11. The group of slits 16 is formed of a plurality of slits that are elongated in the radial direction. The slits are formed symmetrically with respect to the pole center line P.

In this example, the group of slits 16 includes seven slits. More specifically, the group of slits 16 has a slit 16a formed on the pole center line P, slits 16b formed on both sides of the slit 16a, slits 16c formed on both sides of a combination of the slits 16b, and slits 16d formed on both sides of a combination of the slits 16c.

The slit 16a extends on the pole center line P. The slits 16b, 16c, and 16d extend so that inclination angles with respect to the pole center line P increase in the order of the slits 16b, 16c, and 16d. The slits 16a, 16b, 16c, and 16d have lengths decreasing in the order of the slits 16a, 16b, 16c, and 16d. The slits 16a, 16b, 16c, and 16d have the same width of, for example, 1 mm.

The group of slits 16 restrains the magnetic flux flowing from the stator 5 from flowing in the circumferential direction through an outer circumferential region of the rotor core 10 and also rectifies the magnetic flux of the permanent magnets 20 so as to achieve a smooth magnetic flux density distribution on the surface of the rotor 1. Thus, the group of slits 16 is formed as close as possible to the outer circumference 10a of the rotor core 10. The number of slits constituting the group of slits 16 is not limited to seven, but only needs to be one or more.

The tooth 52 of the stator 5 has the tooth tip 52a facing the rotor 1 as described above. Tooth tip ends 52c are formed at both ends of the tooth tip 52a in the circumferential direction. An inclined surface 52d that is inclined with respect to the pole center line P is formed between the tooth tip end 52c and the side surface 52b of the tooth 52.

The slot 53, which is a space to house the coil 55, is formed between adjacent teeth 52. A slot opening 54 is formed on the inner side of the slot 53 in the radial direction. The tooth tip end 52c of the tooth 52 described above faces the slot opening 54. The slot opening 54 serves as an inlet when the coil 55 is housed in the slot 53.

In FIG. 5, the tooth 52 facing the permanent magnet 20 (i.e., the permanent magnet 20 located at the center in FIG. 5), which is a target to be described, is also referred to as a facing tooth 52X. The tooth 52 adjacent to the facing tooth 52X in the circumferential direction is also referred to as an adjacent tooth 52Y. In the state illustrated in FIG. 5, the tooth center line T of the facing tooth 52X and the pole center line P are on the same straight line.

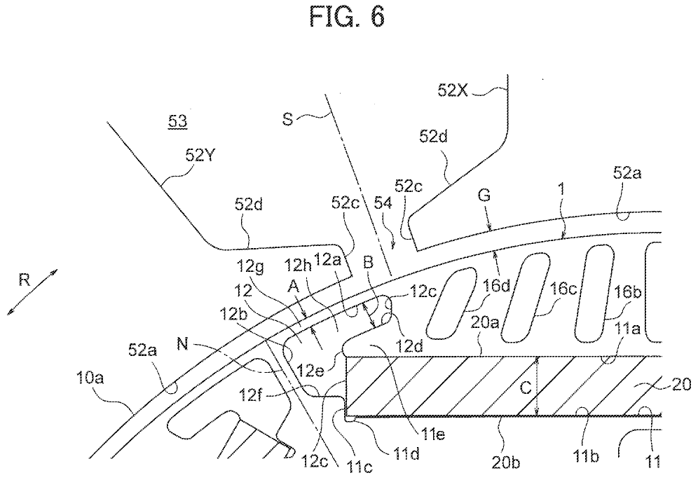

FIG. 6 is an enlarged diagram illustrating the flux barrier 12 of the rotor 1 and its surroundings illustrated in FIG. 5. The flux barrier 12 has an outer edge 12a extending in an arc shape along the outer circumference 10a of the rotor core 10, a side edge 12b which is an edge on the inter-pole portion side, a tip edge 12c which is an edge on the pole center side, an inner edge 12d extending parallel to the outer edge 12a, and a base edge 12f extending between the side edge 12b and the stepped portion 11c.

The side edge 12b extends along the inter-pole center line N, and the tip edge 12c extends parallel to the pole center line P (FIG. 5). The inner edge 12d extends in an arc shape and in parallel to the outer edge 12a, and the base edge 12f extends in a direction perpendicular to the pole center line P (FIG. 5).

A region enclosed by the outer edge 12a, the tip edge 12c, and the inner edge 12d of the flux barrier 12 constitutes a protruding portion 12h of the flux barrier 12 and is located between the end of the magnet insertion hole 11 in the circumferential direction and the outer circumference 10a of the rotor core 10. An iron core portion lie is disposed between the protruding portion 12h of the flux barrier 12 and the magnet insertion hole 11 in the radial direction.

A bridge 12g, which is a thin-walled portion, is formed between the outer edge 12a of the flux barrier 12 and the outer circumference 108 of the rotor core 10. The width of the bridge 12g in the radial direction is desirably constant in the circumferential direction.

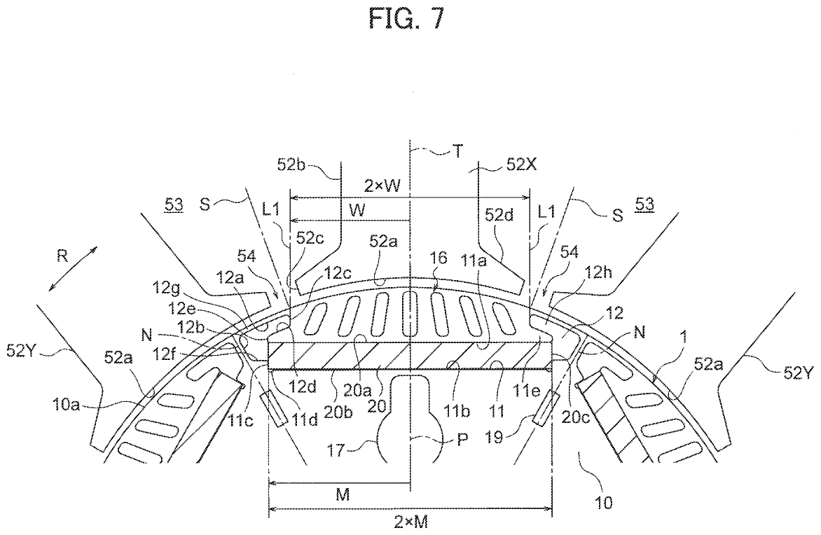

FIG. 7 is a schematic diagram for explaining the positional relationship among the permanent magnet 20, the slot 53, and the tooth 52. The rotor 1 and the stator 5 are in a positional relationship where the tooth center line T of the facing tooth 52X and the pole center line P are located on the same straight line.

As described above, the number of poles (Np) of the rotor 1 is six, and the number of slots (Ns) of the stator 5 is nine. That is, the ratio of the number of poles of the rotor 1 to the number of slots of the stator 5 is 2:3 (Np:Ns=2:3). In this case, the magnetic pole pitch is 180 degrees in electric angle, while the winding pitch is 120 degrees in electric angle.

Thus, the end of the permanent magnet 20 in the width direction faces the tooth tip 52a of the adjacent tooth 52Y in a state where the permanent magnet 20 faces the facing tooth 52X. Therefore, the flux barrier 12 needs to be formed in the rotor core 10 in such a manner as to restrain the magnetic flux of the permanent magnet 20 from flowing into the tooth tip 52a of the adjacent tooth 52Y.

A distance from the pole center line P to the side end surface 20c of the permanent magnet 20 is defined as a distance M. The distance M is half the width (2×M) of the permanent magnet 20. When the width of the permanent magnet 20 is 24 nut, the distance M is 12 mm.

The distance from the pole center line P to the flux barrier 12, more specifically, the distance from the pole center line P to the tip edge 12c of the flux barrier 12, is defined as a distance W. The distance W is half the interval (2×W) between the two flux barriers 12. When an interval between the two flux barriers 12 is 20 mm, the distance W is 10 mm.

The distance W from the pole center line P to the flux barrier 12 is shorter than the distance M from the pole center line P to the side end surface 20c of the permanent magnet 20 (W<M).

The magnet torque of the motor 100 is proportional to the product of an induced voltage generated by the magnetic flux of the permanent magnet 20 interlinked with the coil 55 and a current value of the current flowing through the coil 55. In this regard, since copper loss occurs in proportion to the square of the current value, more magnetic flux of the permanent magnet 20 needs to be interlinked with the coil 55 in order to improve motor efficiency. For this reason, the width of the permanent magnet 20 is desirably as wide as possible.

However, when the width of the permanent magnet 20 is increased, the magnetic flux emitted from the end of the permanent magnet 20 in the width direction (portion including the side end surface 20c) is likely to flow to the adjacent permanent magnet 20 via the tooth tip 52a of the adjacent tooth 52Y. That is, the short circuit of the magnetic flux is likely to occur. If such a short circuit of the magnetic flux occurs, the magnetic flux of the permanent magnet 20 cannot be utilized efficiently.

In the first embodiment, the distance W from the pole center line P to the flux barrier 12 is shorter than the distance M from the pole center line P to the side end surface 20c of the permanent magnet 20 (W<M). Thus, the flux barrier 12 is disposed between the end of the permanent magnet 20 in the width direction and the outer circumference 10a of the rotor core 10.

That is, the flux barrier 12 blocks a magnetic path directed from the end of the permanent magnet 20 in the width direction toward the tooth tip 52a of the adjacent tooth 52Y, and thus the short circuit of the magnetic flux described above can be suppressed.

A straight line parallel to the pole center line P that passes through the tip edge 12c of the flux barrier 12 is defined as a straight line L1. This straight line L1 passes through the inside of the slot opening 54. More desirably, the straight line L1 is located on the facing tooth 52X side with respect to the slot center line S in the slot opening 54. Thus, the interval between the two flux barriers 12 on both sides of the permanent magnet 20 can be made closer to the width of the tooth tip 52a of the tooth 52 in the circumferential direction.

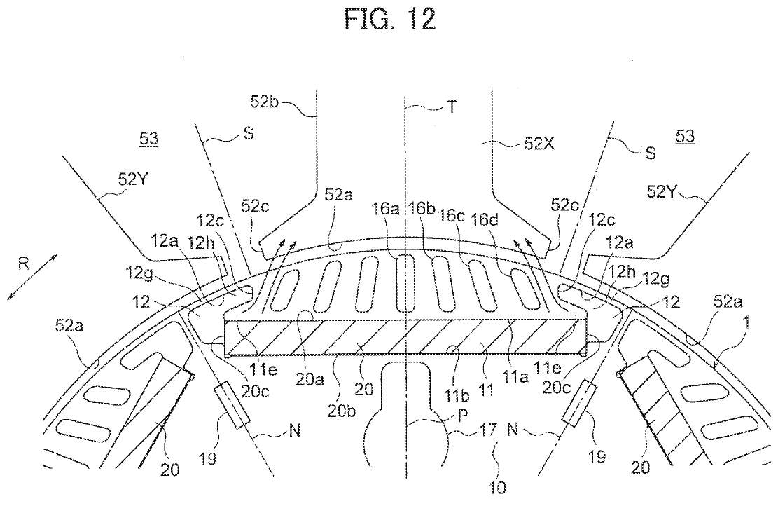

As a result, the magnetic flux emitted from the end of the permanent magnet 20 in the width direction is likely to flow through a region between the two flux barriers 12 and flow into the facing tooth 52X (see FIG. 12 to be mentioned later). Thus, the amount of magnetic flux interlinked with the coils 55 increases, causing an increase in the induced voltage.

As described above, the magnet torque is the product of the induced voltage and the current value. Thus, as the induced voltage increases, the current value can be set to a lower value. Since copper loss of the coil 55 occurs in proportion to the square of the current value, the copper loss can be reduced by setting the current value lower, and thus the motor efficiency can be enhanced.

Next, a configuration to enhance the effect of blocking the magnetic flux by the flux barrier 12 will be described. In FIG. 6, the gap G between the rotor 1 and the stator 5 is larger than the sheet thickness of each electromagnetic steel sheet constituting the rotor core 10, and is, for example, 0.3 to 1.0 mm and is 0.75 mm in this example. The outer circumference 10a of the rotor core 10 is not limited to a circular shape, but may be, for example, a flower circle shape. In such a case, the minimum distance between the rotor 1 and the stator 5 is defined as the gap G.

A distance in the radial direction between the outer edge 12a of the flux barrier 12 and the outer circumference 10a of the rotor core 10, i.e., the width of the bridge 12g in the radial direction, is defined as a width A. The width of the bridge 12g in the radial direction is not necessarily constant, but may change in the circumferential direction. In such a case, the minimum width of the bridge 12g in the radial direction is defined as the width A.

In order to suppress the short circuit of the magnetic flux between the magnetic poles, it is desirable to make the width A of the bridge 12g as narrow as possible so that the magnetic flux from the permanent magnets 20 does not pass through the bridge 12g. Thus, the width A of the bridge 12g is set narrower than the gap G between the rotor 1 and the stator 5.

However, the minimum width of the electromagnetic steel sheet with which the electromagnetic steel sheet can be subjected to press forming is equal to the sheet thickness of the electromagnetic steel sheet. Thus, the width of the bridge 12g is equal to the sheet thickness of each electromagnetic steel sheet that constitutes the rotor core 10, and is 0.35 mm in this example.

The outer edge 12a and the inner edge 12d of the flux barrier 12 are parallel to each other. The distance in the radial direction between the outer edge 12a and the inner edge 12d is defined as a width B of the flux barrier 12. The outer edge 12a and the inner edge 12d of the flux barrier 12 are not limited to being parallel, but may be non-parallel. In such a case, the shortest distance (the minimum width) in the radial direction between the outer edge 12a and the inner edge 12d is defined as the width B.

The width B of the flux barrier 12 is wider than the gap G between the rotor 1 and the stator 5. Thus, the magnetic resistance of the flux barrier 12 is higher than the magnetic resistance of the air gap, and thus the effect of blocking the magnetic flux by the flux barrier 12 can be enhanced. As a result, the short circuit of the magnetic flux between the magnetic poles is suppressed, so that more magnetic flux can be directed to the facing tooth 52X.

An interval between the outer edge 11a and the inner edge 11b of the magnet insertion hole 11 is defined as a width C. The width C is the width of the magnet insertion hole 11 in the thickness direction of the permanent magnet 20. The width C is set larger than the thickness of the permanent magnet 20 by a tolerance so that the permanent magnet 20 can be inserted into and removed from the magnet insertion hole 11.

The width C of the magnet insertion hole 11 is wider than the width B of the flux barrier 12 in the radial direction. The width C of the magnet insertion hole 11 is, for example, 2.00 mm.

The formation of the flux barrier 12 allows the stator magnetic flux generated by the coil current of the stator 5 to flow toward the magnet insertion hole 11. By making the width C of the magnet insertion hole 11 wider than the width B of the flux barrier 12 in the radial direction, the magnetic resistance of the magnet insertion hole 11 in the thickness direction of the permanent magnet 20 can be made higher than the magnetic resistance of the flux barrier 12, and thus demagnetization of the permanent magnet 20 can be suppressed.

In summary, the width A in the radial direction of the bridge 12g of the rotor 1, the width B of the flux barrier 12 in the radial direction, the width C of the magnet insertion hole 11 in the magnet thickness direction, and the gap G between the stator 5 and the rotor 1 satisfy A<G<B<C. Thus, the effect of blocking the magnetic flux in the flux barrier 12 can be enhanced.

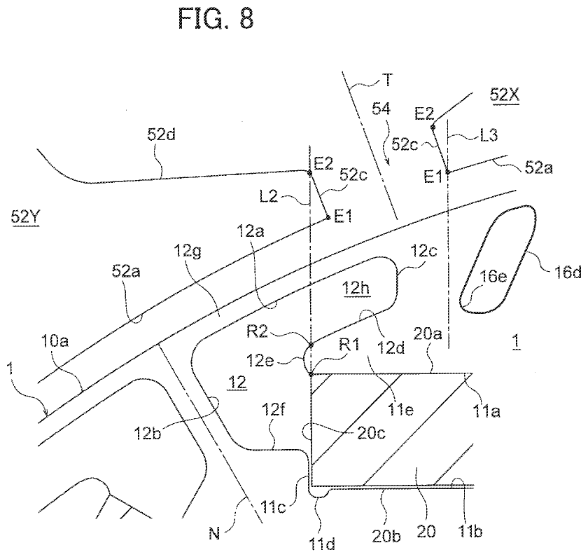

FIG. 8 is a schematic diagram illustrating the positional relationship between the flux barrier 12 and the tooth 52. As illustrated in FIG. 8, a curved portion 12e is formed between the inner edge 12d of the flux barrier 12 and the outer edge 11a. The curved portion 12e has a curved shape that is convex toward the side edge 12b side.

The curved portion 12e of the flux barrier 12 has an end R1 located at the boundary with the outer edge 11a of the magnet insertion hole 11 and an end R2 located at the boundary with the inner edge 12d. The ends R1 and R2 define both ends of the curved portion 12e.

The tooth tip end 52c of the tooth 52 has an inner end E1 in the radial direction and an outer end E2 in the radial direction. The end E1 is the boundary between the tooth tip end 52c and the rotor facing surface of the tooth tip 52a, and the end E2 is the boundary between the tooth tip end 52c and the inclined surface 52d.

A straight line parallel to the pole center line P that passes through the side end surface 20c of the permanent magnet 20 is defined as a straight line L2. The straight line L2 only needs to be a straight line parallel to the pole center line P that passes through any point on the side end surface 20c of the permanent magnet 20.

This straight line L2 passes through the curved portion 12e of the flux barrier 12. Thus, the entire magnetic pole surface 20a of the permanent magnet 20 contacts the iron core portion of the rotor core 10. If a part of the magnetic pole surface 20a of the permanent magnet 20 does not contact the iron core portion, the magnetic flux emitted from the magnetic pole surface 20a cannot be utilized sufficiently. Since the entire magnetic pole surface 20a of the permanent magnet 20 contacts the iron core portion, the magnetic flux of the permanent magnets 20 can be utilized efficiently.

The width of the permanent magnet 20 is desirably wide as described above. However, if the width of the permanent magnet 20 is extremely wide, the size of a vacant portion inside the flux barrier 12 is reduced, which may reduce the effect of blocking the short-circuit magnetic flux in the flux barrier 12.

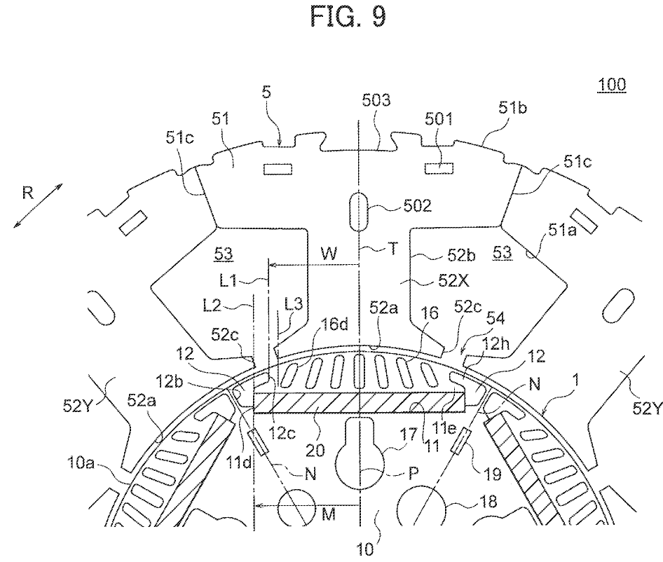

As illustrated in FIG. 9, the maximum width of the permanent magnet 20 is the width at which the straight line L2 parallel to the pole center line P passing through the side end surface 20c of the permanent magnet 20 passes through the tooth tip end 52c of the adjacent tooth 52Y. With this width, the vacant portion in the flux barrier 12 is not extremely reduced, and it is possible to restrain the magnetic flux from flowing into the adjacent permanent magnet 20.

More specifically, as illustrated in FIG. 8, the straight line L2 only needs to pass through any portion between the ends R1 and R2 of the curved portion 12e of the flux barrier 12 and further pass through any portion between the ends E1 and E2 of the tooth tip end 52c of the adjacent tooth 52Y. With this configuration, the short circuit of the magnetic flux can be suppressed while increasing the width of the permanent magnet 20.

It is desirable that the width (2×M) of the permanent magnet 20 is larger than the interval (2×W) between the two flux barriers 12 on both sides of the permanent magnet 20 and is less than 1.3 times the interval. In other words, the distance M from the pole center line P to the side end surface 20c of the permanent magnet 20 and the distance W from the pole center line P to the tip edge 12c of the flux barrier 12 satisfy W<M<1.15×W.

As illustrated in FIG. 8, in a state where the tooth center line T of the facing tooth 52X and the pole center line P are on the same straight line (FIG. 5), a straight line parallel to the pole center line P passing through the tooth tip end 52c of the facing tooth 52X is defined as a straight line L3. The straight line L3 only needs to pass through any portion between the ends E1 and E2 of the tooth tip end 52c of the facing tooth 52X.

The straight line L3 is located between the tip edge 12c of the flux barrier 12 and the slit 16d. More specifically, the straight line L3 is located between the tip edge 12c of the flux barrier 12 and an end 16e of the slit 16d closest to the flux barrier 12.

Thus, the magnetic flux emitted from the end of the permanent magnet 20 in the width direction is likely to flow through a space between the flux barrier 12 and the slit 16d and flow into the tooth tip 52a of the facing tooth 52X. As a result, the magnetic flux of the permanent magnet 20 can be utilized more efficiently.

### (Action)

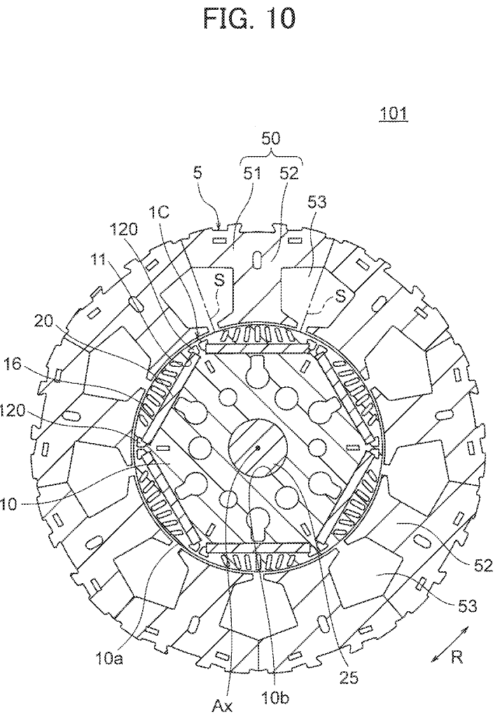

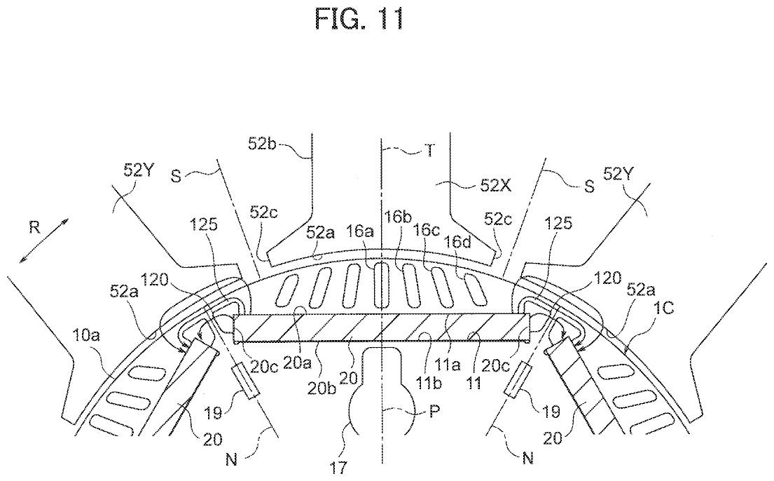

Next, the action of the first embodiment will be described. First, Comparative Example, which is compared with the first embodiment, will be described. FIG. 10 is a sectional view illustrating a motor 101 of Comparative Example. FIG. 11 is a diagram illustrating a portion in which a rotor 1C and a stator 5 in the motor 101 of Comparative Example face each other.

As illustrated in FIG. 10, the motor 101 of Comparative Example differs from the motor 100 of the first embodiment in the shape of flux barriers 120 of the rotor 1C and is the same as the motor 100 of the first embodiment in other points.

As illustrated in FIG. 11, the flux barrier 120 of the rotor 1C does not have a protruding portion 12h (FIG. 5) that blocks a magnetic path directed from the end of the permanent magnet 20 in the width direction toward the adjacent tooth 52Y. Thus, the magnetic flux emitted from the end of the permanent magnet 20 in the width direction is likely to flow to the tooth tip 52a of the adjacent tooth 52Y and flow to the adjacent permanent magnet 20 via the adjacent tooth 52Y as indicated by the arrows in FIG. 11.

In Comparative Example, the width in the radial direction of a bridge 125 between the flux barrier 120 and the outer circumference 10a of the rotor core 10 is wider than the gap between the rotor 1 and the stator 5. Thus, the magnetic flux emitted from the end of the permanent magnet 20 in the width direction is likely to flow through the bridge 125 in the circumferential direction and flow to the adjacent permanent magnet 20.

In Comparative Example, the end of the permanent magnet 20 in the width direction protrudes into inside the flux barrier 120, and thus a part of the magnetic pole surface 20a does not contact an iron core portion of the rotor core 10. Thus, the magnetic flux emitted from the magnetic pole surface 20a cannot be utilized efficiently.

As above, in the motor 101 of Comparative Example 1, the short circuit of the magnetic flux between magnetic poles is likely to occur, and the magnetic flux of the permanent magnet 20 cannot be effectively utilized. Thus, it is difficult to improve the motor efficiency.

FIG. 12 is a diagram for explaining the action of suppressing the short circuit of the magnetic flux in the motor 100 of the first embodiment. In the first embodiment, the magnetic path directed from the end of the permanent magnet 20 in the width direction toward the adjacent tooth 52Y is blocked by the protruding portion 12h of the flux barrier 12. Thus, the magnetic flux of the permanent magnet 20 is restrained from flowing into the adjacent tooth 52Y, whereby more magnetic flux flows into the facing tooth 52X.

Since the entire magnetic pole surface 20a of the permanent magnet 20 contacts the iron core portion of the rotor core 10, the magnetic flux emitted from the magnetic pole surface 20a can be utilized efficiently.

Assuming that the motor 100 of the first embodiment and the motor 101 of Comparative Example have the permanent magnets 20 of the same size, the induced voltage per unit volume of the permanent magnet 20 in the motor 100 of the first embodiment increases by 133. Consequently, the current value required to generate the same torque can be reduced by 13%. Thus, copper loss can be reduced and the motor efficiency can be enhanced. Alternatively, the volume of the permanent magnet 20 can be decreased by 13%, achieving the reduction in size and cost of the motor 100.

The straight line L1 parallel to the pole center line P passing through the tip edge 12c of the flux barrier 12 (FIG. 7) is located within the slot opening 54, and thus the magnetic flux bypassing the flux barrier 12 is likely to flow into the facing tooth 52X. Thus, the magnetic flux emitted from the permanent magnets 20 can be utilized efficiently.

Since the width A in the radial direction of the bridge 12g is narrower than the gap G of the air gap between the rotor 1 and the stator 5, the flow of the magnetic flux passing through the bridge 12g is restrained, so that the short circuit of the magnetic flux via the bridge 12g can be suppressed.

Further, since the width B in the radial direction of the flux barrier 12 is wider than the gap G between the rotor 1 and the stator 5, the magnetic resistance of the flux barrier 12 is made higher than the magnetic resistance of the air gap. Thus, the effect of blocking the magnetic flux by the flux barrier 12 can be enhanced, and thus the short circuit of the magnetic flux can be effectively suppressed.

Furthermore, since the width C of the magnet insertion hole 11 in the thickness direction of the permanent magnet 20 is wider than the width B in the radial direction of the flux barrier 12, the magnetic resistance of the magnet insertion hole 11 in the thickness direction of the permanent magnet 20 is made higher than the magnetic resistance of the flux barrier 12. Thus, the demagnetization of the permanent magnet 20 can be suppressed even though the stator magnetic flux directed toward the magnet insertion hole 11 is increased by the formation of the flux barrier 12 described above.

For the purpose of suppressing the short circuit of the magnetic flux, it is conceivable to form an opening (side slit) that is not continuous to the magnet insertion hole 11, on the outer circumference 10a side with respect to the magnet insertion hole 11 of the rotor core 10. However, in such a case, the iron core portion between the magnet insertion hole 11 and the side slit serves as the magnetic path, through which the magnetic flux of the permanent magnet 20 flows into the adjacent tooth 52Y. Thus, in the case where the side slit is formed, the effect of suppressing the short circuit of the magnetic flux as in the first embodiment cannot be obtained.

### Effects of Embodiment

As described above, in the first embodiment, the rotor core 10 has the flux barrier 12 formed on an outer side of the magnet insertion hole 11 in the radial direction so as to be continuous to the end of the magnet insertion hole 11 in the circumferential direction, and the distance W from the pole center line P to the flux barrier 12 is shorter than the distance M from the pole center line P to the end (i.e., the side end surface 20c) of the permanent magnet 20 in the circumferential direction. The width A in the radial direction of the bridge 12g between the flux barrier 12 and the outer circumference 10a of the rotor core 10, the width B of the flux barrier 12 in the radial direction, the width C of the magnet insertion hole in the thickness direction of the permanent magnet 20, and the gap G between the rotor 1 and the stator 5 satisfy A<G<B<C.

Thus, the flow of the magnetic flux from the permanent magnet 20 to the tooth tip 52a of the adjacent tooth 52Y can be blocked by the flux barrier 12, and thus the short circuit of the magnetic flux between the magnetic poles can be suppressed. Thus, the magnetic flux of the permanent magnet 20 can be utilized efficiently, and the motor efficiency can be improved. Further, since the relationship of A<G<B<C is established, the flow of the magnetic flux passing through the bridge 12g is restrained. Thus, the effect of blocking the magnetic flux in the flux barrier 12 can be enhanced, and the demagnetization of the permanent magnet 20 can be suppressed.

The straight line L1 parallel to the pole center line P passing through the tip edge 12c of the flux barrier 12 passes through the inside of the slot opening 54 in a state where the tooth center line T and the pole center line P are on the same straight line. Thus, most of the magnetic flux emitted from the permanent magnet 20 can be made to flow into the facing tooth 52X, so that the magnetic flux of the permanent magnet 20 can be utilized efficiently.

Furthermore, since the straight line L1 is located on the facing tooth 52X side with respect to the center of the slot opening 54 in the circumferential direction, the magnetic flux emitted from the permanent magnet 20 can be effectively concentrated on the facing tooth 52X. Thus, the magnetic flux of the permanent magnet 20 can be utilized more efficiently.

The curved portion 12e is formed between the inner edge 12d of the flux barrier 12 and the outer edge 11a of the magnet insertion hole 11. The straight line L2 parallel to the pole center line P passing through the curved portion 12e passes through the tooth tip end 52c of the adjacent tooth 52Y in a state where the tooth center line T and the pole center line P are on the same straight line. Thus, the entire magnetic pole surface 20a of the permanent magnet 20 contacts the iron core portion of the rotor core 10, so that the magnetic flux of the permanent magnet 20 can be utilized more efficiently.

The straight line L3 parallel to the pole center line P passing through the tooth tip end 52c of the facing tooth 52X passes through a space between the flux barrier 12 and the end 16e of the slit 16d closest to the flux barrier 12 in a state where the tooth center line T and the pole center line P are on the same straight line. Thus, the magnetic flux of the permanent magnet 20 is likely to flow through the space between the flux barrier 12 and the slit 16d and flow into the facing tooth 52X. Accordingly, the magnetic flux of the permanent magnets 20 can be utilized more efficiently.

Since the ratio of the number of poles of the rotor 1 to the number of slots of the stator 5 is 2:3 and the coils 55 are wound on the teeth 52 in the concentrated winding, the magnetic pole pitch is larger than the winding pitch, and the magnetic flux of the permanent magnet 20 is likely to flow into the adjacent tooth 52Y. However, in the first embodiment, the flow of the magnetic flux of the permanent magnet 20 into the adjacent tooth 52Y can be blocked by the flux barrier 12, so that the short circuit of the magnetic flux can be suppressed effectively even in the motor 100 with the ratio of the number of poles to the number of slots being 2:3.

### Second Embodiment

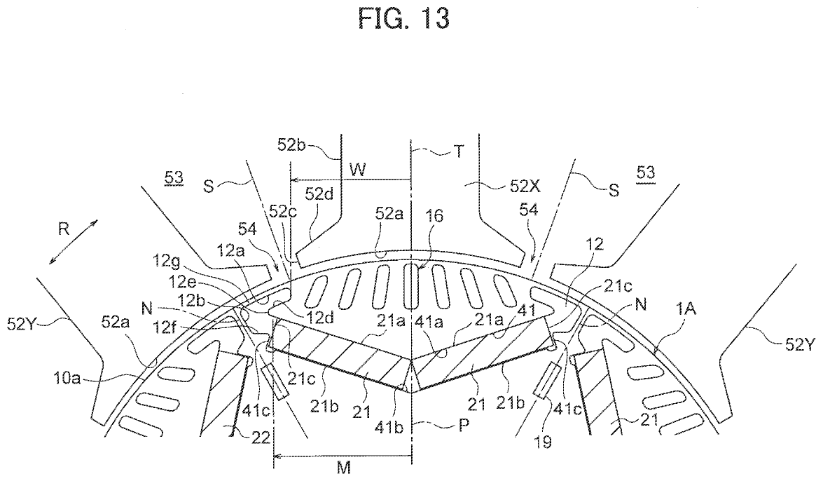

Next, a second embodiment will be described. FIG. 13 is a sectional view illustrating a portion in which a rotor 1A and the stator 5 of the second embodiment face each other. The rotor 1A of the second embodiment has a V-shaped magnet insertion hole 41 for each magnetic pole, and two permanent magnets 21 are inserted in each magnet insertion hole 41. Other configurations are the same as in the first embodiment.

The magnet insertion hole 41 is formed in a V shape such that its center in the circumferential direction protrudes toward the inner circumferential side. The center of the magnet insertion hole 41 in the circumferential direction is the pole center, and a straight line in the radial direction passing through the pole center is the pole center line P.

Two permanent magnets 21 are disposed in the magnet insertion hole 41 on both sides of the pole center line P. The material of the permanent magnet 21 is the same as that of the permanent magnet 20 of the first embodiment. The permanent magnet 20 is in the form of a flat plate, and has a magnetic pole surface 21a located on the outer side in the radial direction, a back surface 21b located on the inner side in the radial direction, and side end surfaces 21c located on both sides in the circumferential direction.

The magnet insertion hole 41 has an outer edge 41a located on the outer side in the radial direction and an inner edge 41b located on the inner side in the radial direction. The outer edge 41a of the magnet insertion hole 41 faces the magnetic pole surfaces 21a of the permanent magnets 21, while the inner edge 41b of the magnet insertion hole 41 faces the back surfaces 21b of the permanent magnets 21.

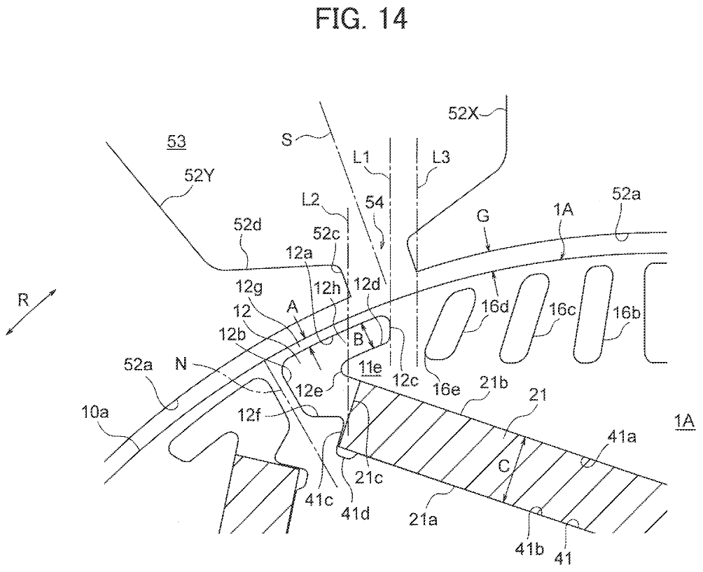

Stepped portions 41c that contact the side end surfaces 21c of the permanent magnets 21 are foamed on both sides of the inner edge 41b of the magnet insertion hole 41 in the circumferential direction. A groove 41d (FIG. 14) is formed between the inner edge 41b and the stepped portion 41c of the magnet insertion hole 41. The stepped portion 41c and the groove 41d are the same as the stepped portion 11c and the groove 11d described in the first embodiment, respectively. A protrusion for positioning the permanent magnets 21 may be formed at the center of the magnet insertion hole 41 in the circumferential direction.

Flux barriers 12 are formed at both ends of the magnet insertion hole 41 in the circumferential direction. Each flux barrier 12 extends from the end of the magnet insertion hole 41 in the circumferential direction toward the outer circumference 10a of the rotor core 10. A group of slits 16 is formed between the outer circumference 10a of the rotor core 10 and the magnet insertion hole 41. The group of slits 16 is as described in the first embodiment.

FIG. 14 is an enlarged diagram illustrating the flux barrier 12 of the rotor 1A and its surroundings illustrated in FIG. 13. As in the first embodiment, the flux barrier 12 has the outer edge 12a, the side edge 12b, the tip edge 12c, the inner edge 12d, and the base edge 12f. A bridge 12g is formed between the outer edge 12a of the flux barrier 12 and the outer circumference 10a of the rotor core 10.

The protruding portion 12h enclosed by the outer edge 12a, tip edge 12c, and inner edge 12d of the flux barrier 12 is located between the end of the magnet insertion hole 41 in the circumferential direction and the outer circumference 10a of the rotor core 10. The iron core portion 11e is disposed between the protruding portion 12h of the flux barrier 12 and the magnet insertion hole 41.

As illustrated in FIG. 13, in the second embodiment, the width direction of the permanent magnet 21 is inclined to the pole center line P. For this reason, a distance M is defined as the distance from the pole center line P to the center point of the side end surface 21c of the permanent magnet 21 in the magnet thickness direction. The distance W is as described in the first embodiment. The distance W is shorter than the distance M(W<M).

The width A in the radial direction of the bridge 12g of the rotor LA, the width B of the flux barrier 12 in the radial direction, the width C of the magnet insertion hole 41 in the magnet thickness direction, and the gap G between the rotor LA and the stator 5 satisfy A<G<B<C, as in the first embodiment.

As illustrated in FIG. 14, the straight line L1 parallel to the pole center line P passing through the tip edge 12c of the facing flux barrier 12 passes through the inside of the slot opening 54 in a state where the tooth center line T of the facing tooth 52X and the pole center line P are on the same straight line.

Furthermore, the straight line L2 parallel to the pole center line P passing through the side end surface 21c of the permanent magnet 21 passes through the curved portion 12e of the flux barrier 12 and further passes through the tooth tip end 52c of the adjacent tooth 52Y in a state where the tooth center line T of the facing tooth 52X and the pole center line P are on the same straight line.

Moreover, the straight line L3 parallel to the pole center line P passing through the tooth tip end 52c of the facing tooth 52X passes through a space between the tip edge 12c of the flux barrier 12 and the end 16e of the slit 16d closest to the flux barrier 12 in a state where the tooth center line T of the facing tooth 52X and the pole center line P are on the same straight line.

With the configuration described above, also in the second embodiment, the flow of the magnetic flux from the permanent magnet 21 to the tooth tip 52a of the adjacent tooth 52Y can be blocked by the flux barrier 12, and thus the short circuit of the magnetic flux between the magnetic poles can be suppressed, as in the first embodiment. Thus, the magnetic flux of the permanent magnets 21 can be utilized efficiently, leading to an improvement in the motor efficiency.

In this example, two permanent magnets 21 are disposed in each magnet insertion hole 41, but three or more permanent magnets may be disposed in each magnet insertion hole.

### (Compressor)

Next, the compressor 300 to which the motors of the first and second embodiments are applicable will be described. FIG. 15 is a sectional view illustrating the compressor 300. The compressor 300 is a rotor compressor in this example, and includes the sealed container 307, a compression mechanism 301 disposed in the sealed container 307, and the motor 100 that drives the compression mechanism 301.

The compression mechanism 301 includes a cylinder 302 having a cylinder chamber 303, a shaft 25 of the motor 100, a rolling piston 304 fixed to the shaft 25, a vane (not shown) dividing the inside of the cylinder chamber 303 into a suction side and a compression side, and an upper frame 305 and a lower frame 306 which close the end surfaces of the cylinder chamber 303 in the axial direction. An upper discharge muffler 308 and a lower discharge muffler 309 are mounted onto the upper frame 305 and the lower frame 306, respectively.

The sealed container 307 is a cylindrical container. At the bottom of the sealed container 307, refrigerant oil (not shown) is stored to lubricate sliding parts of the compression mechanism 301. The shaft 25 is rotatably held by the upper frame 305 and the lower frame 306 which serve as bearings.

The cylinder 302 includes the cylinder chamber 303 therein, and the rolling piston 304 eccentrically rotates within the cylinder chamber 303. The shaft 25 has an eccentric shaft portion, and the rolling piston 304 is fitted to the eccentric shaft portion.

The stator 5 of the motor 100 is incorporated in a frame of the sealed container 307 by a method such as shrink-fitting, press-fitting, or welding. The coils 55 of the stator 5 are supplied with electric power through glass terminals 311 fixed to the sealed container 307. The shaft 25 is fixed to the inner circumference 10b of the rotor 1.

An accumulator 310 is attached to the outside of the sealed container 307. The accumulator 310 has a suction pipe 314 into which the refrigerant gas flows from the refrigerant circuit and a liquid refrigerant storage unit 315 that stores the liquid refrigerant. When the liquid refrigerant flows in through the suction pipe 314 together with the refrigerant gas, the liquid refrigerant is stored in the liquid refrigerant storage unit 315, while the refrigerant gas is supplied to the compressor 300. The accumulator 310 is also called a suction muffler because it exhibits a muffling effect.

A suction pipe 313 is fixed to the sealed container 307, and through this suction pipe 313, the refrigerant gas is supplied from the accumulator 310 to the cylinder 302. In addition, a discharge pipe 312 is provided at the top of the sealed container 307 to discharge the refrigerant to the outside.

For example, R410A, R407C, or R22 may be used as the refrigerant for the compressor 300. From the viewpoint of global warming prevention, it is desirable to use a refrigerant with a low GWP (global warming potential). As the refrigerant with a low GWP, it is possible to use the following refrigerants.
(1) First, a halogenated hydrocarbon having a carbon-carbon double bond in its composition, for example, HFO (Hydro-Fluoro-Orefin)-1234yf (CF₃CF═CH₂), can be used. The GWP of HFO-1234yf is 4.
(2) Alternatively, a hydrocarbon having a carbon-carbon double bond in its composition, for example, R1270 (propylene), may be used. The GWP of R1270 is 3, which is lower than that of HFO-1234yf, but R1270 has higher flammability than HFO-1234yf.
(3) A mixture containing at least one of the halogenated hydrocarbon having the carbon-carbon double bond in its composition and the hydrocarbon having the carbon-carbon double bond in its composition may be used. For example, a mixture of HFO-1234yf and R32 may be used. HFO-1234yf described above is a low-pressure refrigerant and thus tends to increase a pressure drop, which may lead to reduction in the performance of the refrigeration cycle (particularly, an evaporator). For this reason, it is desirable to use a mixture of HFO-1234yf with R32 or R41, which is a higher pressure refrigerant than HFO-1234yf.

The operation of the compressor 300 is as follows. The refrigerant gas supplied from the accumulator 310 is supplied into the cylinder chamber 303 of the cylinder 302 through the suction pipe 313. When the motor 100 is driven by application of current by the inverter and the rotor 1 rotates, the shaft 25 rotates together with the rotor 1. Then, the rolling piston 304 fitted to the shaft 25 eccentrically rotates in the cylinder chamber 303, thereby compressing the refrigerant in the cylinder chamber 303. The refrigerant compressed in the cylinder chamber 303 passes through the discharge mufflers 308 and 309 and further through the holes 17 and 18 of the rotor 1 and the like (FIG. 4) to rise inside the sealed container 307. The refrigerant rising inside the sealed container 307 is discharged through the discharge pipe 312 and supplied to the high-pressure side of the refrigerant cycle.

The motor 100 of the compressor 300 has high motor efficiency as described in the first and second embodiments, and thus the operating efficiency of the compressor 300 can be improved.

The motor 100 of each of the first and second embodiments can be utilized not only in the rotary compressor, but also in other types of compressors.

### (Air Conditioner)

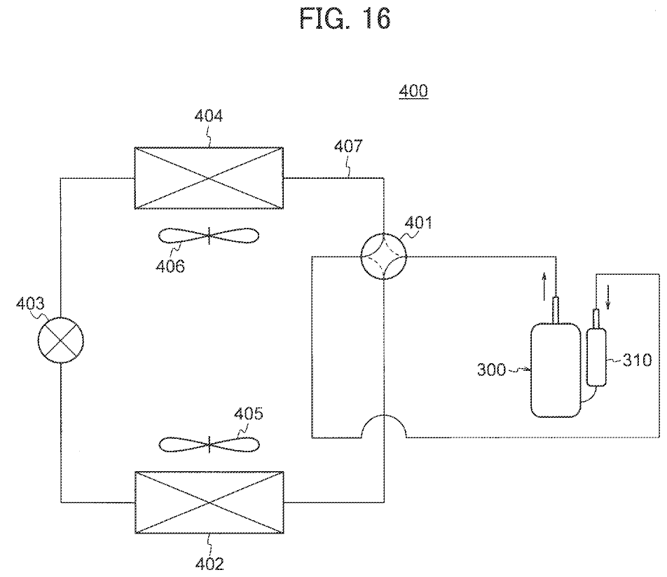

Next, an air conditioner 400 as the refrigeration cycle apparatus including the compressor 300 of FIG. 15 will be described. FIG. 16 is a diagram illustrating the air conditioner 400 that includes the compressor 300 illustrated in FIG. 15. The air conditioner 400 includes the compressor 300, a four-way valve 401 as a switching valve, a condenser 402 that condenses the refrigerant, a decompressor 403 that decompresses the refrigerant, and an evaporator 404 that evaporates the refrigerant.

The compressor 300, the condenser 402, the decompressor 403, and the evaporator 404 are connected together by a refrigerant pipe 407 to configure a refrigerant circuit. The air conditioner 400 includes an outdoor fan 405 facing the condenser 402 and an indoor fan 406 facing the evaporator 404.

The operation of the air conditioner 400 is as follows. The compressor 300 compresses the sucked refrigerant and discharges the compressed refrigerant as high-temperature and high-pressure refrigerant gas. The four-way valve 401 switches the flow direction of the refrigerant. During a cooling operation, the four-way valve 401 makes the refrigerant discharged from the compressor 300 flow to the condenser 402 as indicated by the solid line in FIG. 16.

The condenser 402 exchanges heat between the refrigerant discharged from the compressor 300 and the outdoor air fed by the outdoor fan 405 to condense the refrigerant and discharges the condensed refrigerant as liquid refrigerant. The decompressor 403 expands the liquid refrigerant discharged from the condenser 402 and then discharges the liquid refrigerant as a low-temperature and low-pressure liquid refrigerant.

The evaporator 404 exchanges heat between the low-temperature and low-pressure liquid refrigerant discharged from the decompressor 403 and the indoor air to evaporate the refrigerant and then discharges the evaporated refrigerant as the refrigerant gas. Air from which the heat is taken in the evaporator 404 is supplied by the indoor fan 406 to the interior of a room.

During a heating operation, the four-way valve 401 sends the refrigerant discharged from the compressor 300, to the evaporator 404. In this case, the evaporator 404 functions as a condenser, while the condenser 402 functions as an evaporator.

The air conditioner 400 has the compressor 300, the operating efficiency of which is improved by applying the motor 100 described in each embodiment thereto. Thus, the operating efficiency of the air conditioner 400 can be improved. Although the air conditioner 400 has been described as an example of the refrigeration cycle apparatus, other refrigeration cycle apparatuses, such as refrigerators, may also be used.

Although the desirable embodiments have been specifically described above, various modifications or changes can be made to the present disclosure based on the above-mentioned embodiments.

1. A motor comprising:
a stator in an annular shape extending in a circumferential direction about an axis; and
a rotor provided on an inner side of the stator in a radial direction about the axis,
wherein the rotor has a rotor core having a magnet insertion hole and a permanent magnet inserted in the magnet insertion hole, the permanent magnet being in the form of a flat plate,
wherein the rotor core further has a flux barrier formed on an outer side of the magnet insertion hole in the radial direction so as to be continuous to an end of the magnet insertion hole in the circumferential direction,
wherein when a straight line in the radial direction passing through a center of the magnet insertion hole in the circumferential direction is defined as a pole center line, a distance W from the pole center line to the flux barrier is shorter than a distance M from the pole center line to an end of the permanent magnet in the circumferential direction, and
wherein a width A in the radial direction of a bridge formed between the flux barrier and an outer circumference of the rotor core, a width B of the flux barrier in the radial direction, a width C of the magnet insertion hole in a thickness direction of the permanent magnet, and a gap G between the rotor and the stator satisfy A<G<B<C.

2. The motor according to claim 1, wherein the stator has a yoke surrounding the rotor, two or more teeth protruding from the yoke toward the rotor, and a slot formed between the two or more teeth,
wherein the slot has a slot opening facing the rotor, and
wherein when a straight line extending in the radial direction through a center in the circumferential direction of a tooth facing the permanent magnet among the two or more teeth is defined as a tooth center line, a straight line parallel to the pole center line passing through an edge of the flux barrier on the pole center line side passes through an inside of the slot opening in a state where the tooth center line and the pole center line are on a same straight line.

3. The motor according to claim 2, wherein the straight line parallel to the pole center line passing through the edge of the flux barrier on the pole center line side is located on a side of the tooth facing the permanent magnet with respect to a center of the slot opening in the circumferential direction in the state where the tooth center line and the pole center line are on the same straight line.

4. The motor according to claim 2, wherein each of the two or more teeth has a tooth tip facing the rotor, and
wherein the tooth tip has a tooth tip end defining the slot opening.

5. The motor according to claim 4, wherein a curved portion is formed between the flux barrier and an outer edge of the magnet insertion hole in the radial direction, and
wherein a straight line parallel to the pole center line passing through the curved portion passes through a tooth tip end of another tooth adjacent to the tooth in a state where the tooth center line and the pole center line are on the same straight line.

6. The motor according to claim 4, wherein the rotor core has a slit in a region on an outer side of the magnet insertion hole in the radial direction, and
wherein a straight line parallel to the pole center line passing through the tooth tip end of the tooth facing the permanent magnet passes through a space between the flux barrier and an end of the slit closest to the flux barrier.

7. The motor according to claim 3, wherein a coil is wound around each of the two or more teeth of the stator in concentrated winding, and
wherein a ratio of a number of poles in the rotor to a number of teeth is 2:3.

8. The motor according to claim 1, wherein the flux barrier has a region extending along the outer circumference of the rotor core, and
wherein an iron core portion of the rotor core is located between the region and the magnet insertion hole in the radial direction.

9. The motor according to claim 1, wherein the permanent magnet has a magnetic pole surface facing the outer circumference of the rotor core, and
wherein the entire magnetic pole surface contacts an iron core portion of the rotor core.

10. The motor according to claim 1, wherein the magnet insertion hole extends linearly in a direction perpendicular to the pole center line or extends in a V shape such that the center of the magnet insertion hole protrudes inward in the radial direction.

11. A compressor comprising:
the motor according to claim 1; and
a compression mechanism driven by the motor.

12. A refrigeration cycle apparatus comprising:
the compressor according to claim 11;
a condenser to condense a refrigerant discharged from the compressor;
a decompressor to decompress the refrigerant condensed by the condenser; and
an evaporator to evaporate the refrigerant decompressed by the decompressor.

13. The motor according to claim 1, wherein a straight line parallel to the pole center line passing through the end of the permanent magnet passes through a curved portion formed between the flux barrier and an outer edge of the magnet insertion hole in the radial direction.
